(19) United States
(12) Patent Application Publication
(10) Pub. No.: US 2014/0048755 A1
(43) Pub. Date: Feb. 20, 2014

(54) Roll Claw

(71) Applicant: Thomas Bryant, Dahlonega, GA (US)

(72) Inventor: Thomas Bryant, Dahlonega, GA (US)

(21) Appl. No.: 13/585,776

(22) Filed: Aug. 14, 2012

(51) Int. Cl. B25C 11/00; B66F 15/00

(52) U.S. Cl. CPC B25C 11/00; B66F 15/00
USPC 254/25; 254/30

(57) ABSTRACT

The Roll Claw is a complementary tool with a purpose of using less stress force to do work. It is made with a rounded head and a claw end. It has a square portal that accepts a ratchet or pull handle of any make, and a round portal that accepts a chain link of any make where a tension strap with a hook can be attached. Measurements are noted in detailed explanations.

### DESCRIPTION OF DRAWING VIEWS

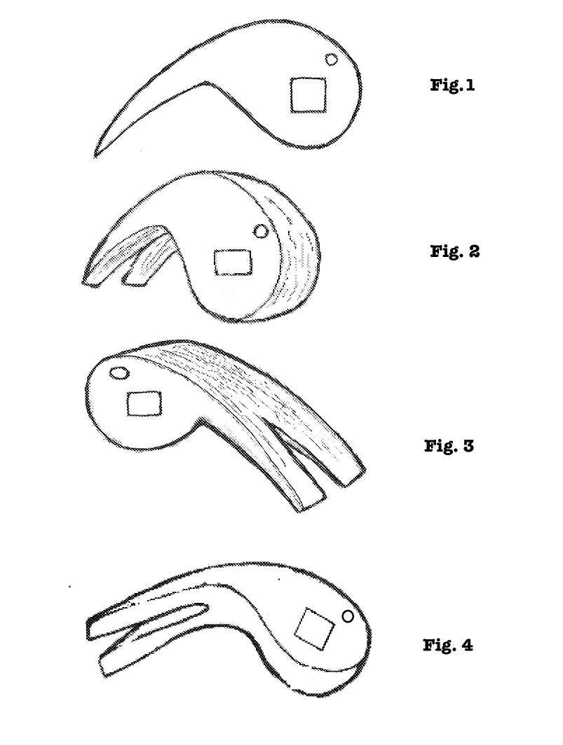

1. FIG. 1 shows a side view of the Roll Claw. Reverse side of the Roll Claw is a mirror image.

2. FIG. 2 shows a rotation of the Roll Claw showing the rounded head and the claw portion on the tool is also visible.

3. FIG. 3 is a view of the Roll Claw from above showing the rounded head portion and the claw.

4. FIG. 4 is a side view of the Roll Claw showing the rounded head, claw.

### DETAILED DESCRIPTION OF ROLL CLAW

The Roll Claw is a tool that uses leverage to reduce the stress force to perform certain work. Each drawing of this tool shows a square hole that accepts a ratchet or pull bar of any make. The longer the handle used with the Roll Claw, the less force is needed. The shorter the handle allows the tools use in confined spaces. Since less force is required, persons with limited strength would be able to remove nails or separate two items. While the dimensions of the Roll Claw will remain the same, the square portal in the tool will be made in sizes to accommodate a ratchet or pull bar, of any make, in the sizes 0.377, 0.502 and 0.752. The round hole that is visible in the Roll Claw drawings is 0.160, and accepts a 0.156 chain link pin. This pin is used to attach a pull strap with an attached hook. With a strap attached to the Roll Claw, objects that are round or square can be rotated or lifted without scaring the surface of the object (ex. rotating large pipes, columns, or filters of all sizes). The Roll Claw is made as a single item. It has an R. C. hardness range of 42-44. The length of the tool as in FIG. 1 is 4 inches and the width of the Roll Claw is 0.678. The width of the claw is 1.200.

### BACKGROUND OF THE INVENTION

To create a more universal tool. A tool that would use less stress-force to do work.

### BRIEF SUMMARY OF THE INVENTION

The Roll Claw is a tool that works on a leverage basis. The tool is to be used with a ratchet, pull handle or tension band of any make.

1. The Roll Claw when used with a ratchet or pull handle will extract nails from open and confined spaces, pry objects apart, and assist persons with limited strength in the removal and separation of said objects.

2. With the attachment of a tension band, round or square objects like pipes or poles can be rotated or lifted.
